(19) United States
(12) Patent Application Publication
(10) Pub. No.: US 2020/0125573 A1
(43) Pub. Date: Apr. 23, 2020

(54) IMPLEMENTING IN-STORAGE DATA PROCESSING ACROSS MULTIPLE COMPUTATIONAL STORAGE DEVICES

(71) Applicant: ScaleFlux, Inc., San Jose, CA (US)

(72) Inventors: Tong Zhang, Albany, NY (US); Yang Liu, Milpitas, CA (US); Fei Sun, Irvine, CA (US); Hao Zhong, Los Gatos, CA (US)

(21) Appl. No.: 16/657,033

(22) Filed: Oct. 18, 2019

Related U.S. Application Data
(60) Provisional application No. 62/748,433, filed on Oct. 20, 2018.

(51) Int. Cl. G06F 16/2455; G06F 16/22; G06F 16/23

(52) U.S. Cl. CPC G06F 16/24568; G06F 16/2379; G06F 16/2272

(57) ABSTRACT

A host-assisted method for accelerating a streaming computation task, including: storing a plurality of data segments x to be processed for the streaming computation task among a plurality of computational storage devices; at the computational storage device in which a next data segment xᵢ to be processed for the streaming computation task is stored: receiving, from a host, an intermediate result uᵢ₋₁ of the streaming computation task; performing a next streaming computation of the streaming computation task on the data segment xᵢ using the received intermediate result uᵢ₋₁ to generate an intermediate result uᵢ of the streaming computation task; and sending the intermediate result uᵢ of the streaming computation task to the host.

### TECHNICAL FIELD

The present disclosure relates to the field of computational storage, and particularly to cohesively utilizing multiple computational storage devices to accelerate computation.

### BACKGROUND

As the scaling of semiconductor technology (also known as Moore's Law) slows down and approaches an end, the computing power/capability of CPUs can no longer continue to noticeably improve. This makes it increasingly inevitable to complement CPUs with other computing devices such as GPUs and FPGAs that can much more efficiently handle certain computation-intensive workloads. This leads to so-called heterogeneous computing. For many data-intensive applications, computational storage can complement CPUs to implement highly effective heterogeneous computing platforms. The essence of computational storage is to empower data storage devices with additional processing or computing capability. Loosely speaking, any data storage device (e.g., HDD, SSD, or DIMM) that can carry out any data processing tasks beyond its core data storage duties can be classified as computational storage. One desirable property of computational storage is that the total computing capability increases with the data storage capacity. When computing systems deploy multiple computational storage devices to increase the storage capacity, the aggregated computing capability naturally increases as well.

With multiple storage devices, computing systems typically distribute one file or a big chunk of data across multiple storage devices in order to improve data access parallelism. However, such distributed data storage could cause severe resource contention when utilizing computational storage devices to accelerate streaming computation tasks with a sequential data access pattern (e.g., encryption and checksum).

### SUMMARY

Accordingly, embodiments of the present disclosure are directed to methods for utilizing multiple computational storage devices to accelerate streaming computation tasks.

A first aspect of the disclosure is directed to a host-assisted method for accelerating a streaming computation task, including: storing a plurality of data segments x to be processed for the streaming computation task among a plurality of computational storage devices; at the computational storage device in which a next data segment xᵢ to be processed for the streaming computation task is stored: receiving, from a host, an intermediate result uᵢ₋₁ of the streaming computation task; performing a next streaming computation of the streaming computation task on the data segment xᵢ using the received intermediate result uᵢ₋₁ to generate an intermediate result uᵢ of the streaming computation task; and sending the intermediate result uᵢ of the streaming computation task to the host.

A second aspect of the disclosure is directed to method for reducing resource contention while performing a plurality of streaming computation tasks in a system including a host coupled to a plurality of computational storage devices, including: for each of the plurality of streaming computation tasks: for each data segment of a plurality of data segments to be processed for the streaming computation task: randomly choosing a computational storage device from the plurality of computational storage devices; and storing the data segment to be processed for the streaming computation task in the randomly chosen computational storage device.

A third aspect of the disclosure is directed to a storage system for performing a streaming computation task, including: a plurality of computational storage devices for storing a plurality of data segments x to be processed for the streaming computation task; and a host coupled to the plurality of computational storage devices, wherein, the computational storage device in which a next data segment xᵢ to be processed for the streaming computation task is stored is configured to: receive, from the host, an intermediate result uᵢ₋₁ of the streaming computation task; perform a next streaming computation of the streaming computation task on the data segment xᵢ using the received intermediate result uᵢ₋₁ to generate an intermediate result uᵢ of the streaming computation task; and send the intermediate result uᵢ of the streaming computation task to the host.

### BRIEF DESCRIPTION OF THE DRAWINGS

The numerous advantages of the present disclosure may be better understood by those skilled in the art by reference to the accompanying figures.

FIG. 1 illustrates the architecture of an illustrative computational storage device according to embodiments.

FIG. 2 illustrates an operational flow diagram of a process for utilizing one computational storage device to carry out a computation.

FIG. 3 illustrates data striping across multiple computational storage devices.

FIG. 4 illustrates an operational flow diagram of a host-assisted approach for utilizing multiple computational storage devices to carry out a streaming computation task according to embodiments.

FIG. 5 illustrates an operational flow diagram of a process for realizing randomized data placement according to embodiments.

FIG. 6 illustrates an operational flow diagram of a process for realizing randomized data placement according to additional embodiments.

### DETAILED DESCRIPTION

Reference will now be made in detail to embodiments of the disclosure, examples of which are illustrated in the accompanying drawings.

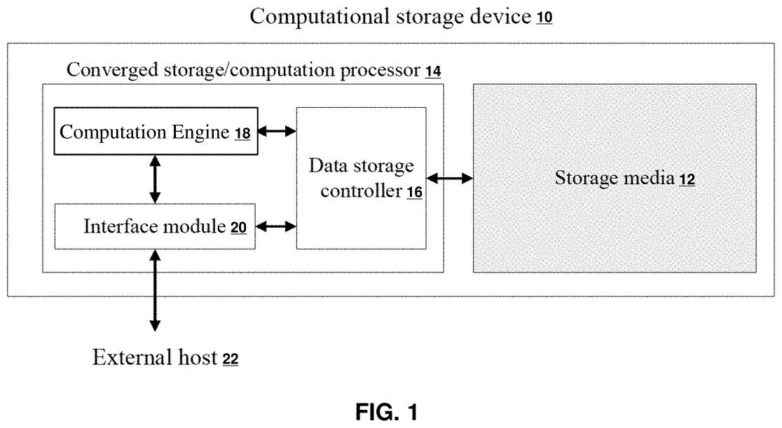

FIG. 1 illustrates the architecture of a computational storage device 10 that includes storage media 12 (e.g., flash memory chips) and a converged storage/computation processor 14 (hereafter referred to as storage/computation processor 14) according to embodiments. The storage/computation processor 14 includes a data storage controller 16 that manages the storage media 12 and data read/write from/to the storage media 12. The storage/computation processor 14 further includes a computation engine 18 that carries out data computation in the computational storage device 10, and an interface module 20 that is responsible for interfacing with one or more external devices (e.g., an external host computing system 22, hereafter referred to as host 22).

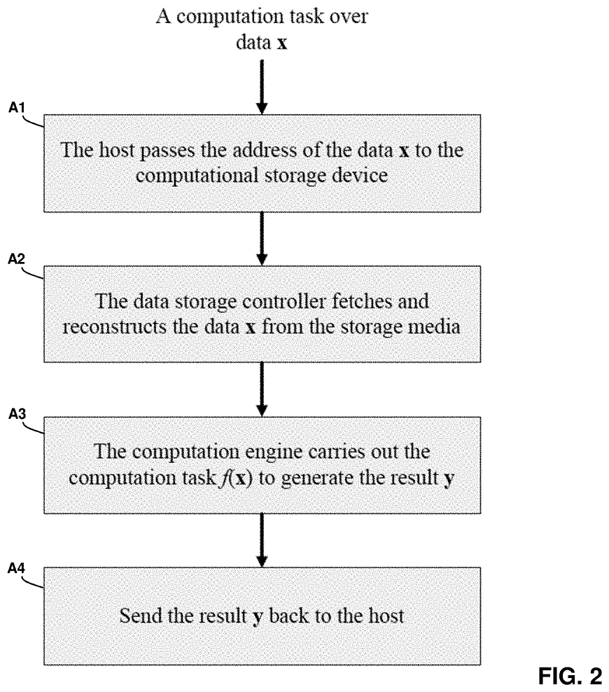

Computational storage devices can perform in-line computation on the data read path, as illustrated in FIG. 2. Suppose a host 22 needs to perform a computation task y=f(x), where x denotes the data being stored in a computational storage device 10 and y denotes the result of the computation. As shown in FIG. 2, at process A1, the host 22 passes the address of the data x to the computational storage device 10. At process A2, the data storage controller 16 fetches and reconstructs the data x from the storage media 12. At process A3, the data storage controller 16 feeds the data x to the computation engine 18, which carries out the computation task f(x) to generate the result y in accordance with y=f(x). Finally, the result y is sent back to the host 22 at process A4.

Streaming computation tasks (e.g., encryption and checksum) must process the data in a strictly sequential manner, which is called streaming computation. For example, for to-be-processed data x=[x₀, x₁, . . . , xₙ₋₁], a streaming computation task must complete the processing of data xᵢ₋₁ before processing xᵢ.

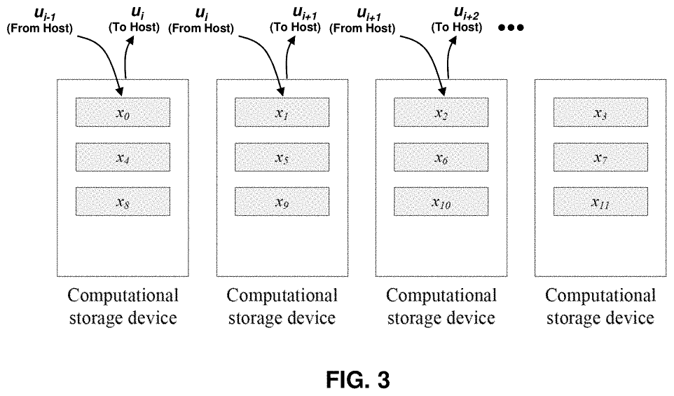

For computing systems that contain multiple computational storage devices, data striping is typically applied across multiple computational storage devices in order to improve data access parallelism and hence improve data access speed performance. As illustrated in FIG. 3, for example, a computing system may include a plurality (e.g., four as shown) computational storage devices. Given one file or a large chunk of data, the computing system partitions file/chunk into a plurality (e.g. twelve) equal-size segments, where each segment contains a relatively small number (e.g., 16 or 64) of consecutive sectors. The computing system distributes all the segments across the four storage devices, which may improve data access parallelism.

However, when striping data across multiple computational storage devices, a streaming computation task may require data from multiple computational storage devices. As a result, the computation engine in any one computational storage device cannot accomplish the entire streaming computation on its own.

According to embodiments, a host-assisted method is provided that can enable multiple computational storage devices 10 to collectively realize the streaming computation. For any streaming computation task over the data x=[x₀, x₁, . . . , xₙ₋₁], in order to carry out the computation on the data segment xᵢ, all the proceeding i−1 data segments (i.e., x₀, x₁, . . . , xᵢ₋₁) should already have been processed to produce an intermediate result uᵢ₋₁.

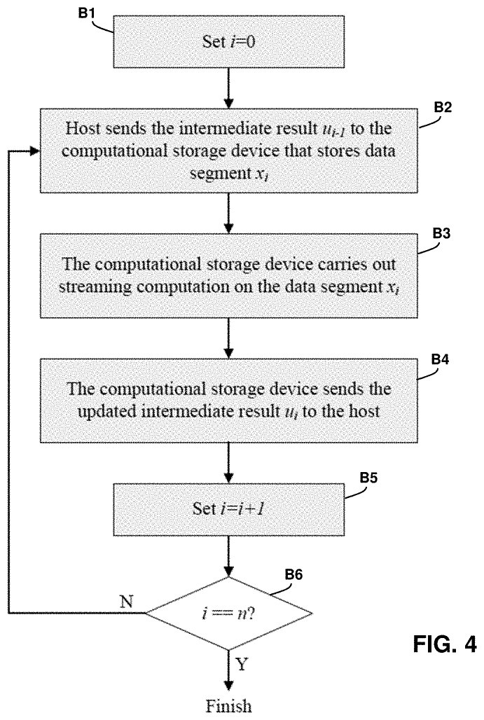

FIG. 4 illustrates an operational flow diagram of a host-assisted approach for utilizing multiple computational storage devices 10 to carry out a computation task (e.g., a streaming computation task) according to embodiments. At process B1, i is set to 0 (i=0). At process B2, in order to utilize the computation engine 18 in a computational storage device 10 to carry out a streaming computation on a data segment xᵢ, the host 22 first sends the required intermediate result to the computational storage device 10 in which the data segment xᵢ is stored (e.g., see FIG. 3). The initial intermediate result u₋₁ has a fixed pre-defined value. At process B3, after receiving the intermediate result uᵢ₋₁, the computation engine 18 in the computational storage device 10 in which the data segment xᵢ is stored carries out the computation on the data segment xᵢ to produce an intermediate result uᵢ. At process B4, the computational storage device 10 sends the intermediate result uᵢ back to the host 22. At process B5, i is incremented by 1 (i=i+1) and flow passes back to process B2. Processes B2-B5 are repeated until all of the n data segments have been processed (Y at process B6).

In the above-described host-assisted streaming computation, for each streaming computation task, only one computational storage device 10 can carry out the streaming computation at one time. According to embodiments, to better leverage the computation engines 18 in a plurality of computational storage devices 10, multiple concurrent streaming computation tasks may be performed over different sets of data. Given multiple concurrent streaming computation tasks, the host 22 can use an operational flow similar to that illustrated in FIG. 4 to schedule all the tasks among all the computational storage devices 10 concurrently.

In order to improve the achievable operational parallelism, it is highly desirable to reduce computation resource contention, i.e., reduce the probability that one computational storage device 10 is scheduled to serve two or more streaming computation tasks at the same time. Given the data x=[x₀, x₁, . . . , xₙ₋₁] and m computational storage devices (denoted as S₀, S₁, . . . , Sₘ₋₁), conventional practice simply stores each data segment on the computational storage device Sⱼ, where j=i mod m. All the data are striped across all the computational storage devices 10 in the exactly same pattern. However, such a conventional data placement approach may cause severe resource contention. For example, if multiple streaming computation tasks start at the same time, they will always compete for the resource in the first computational storage device S₀.

In order to reduce such resource contention, randomized data placement methods are presented. In particular, according to embodiments, if a plurality of streaming computation tasks collide at one computational storage device 10 (i.e., the streaming computation tasks need to process data segments on the same computational storage device 10), then most likely the tasks will subsequently move on to different computational storage devices 10. Randomized data placement can be implemented in different manners, and below two possible implementations for randomized data placement for the data segments in each of a plurality of streaming computation tasks are presented.

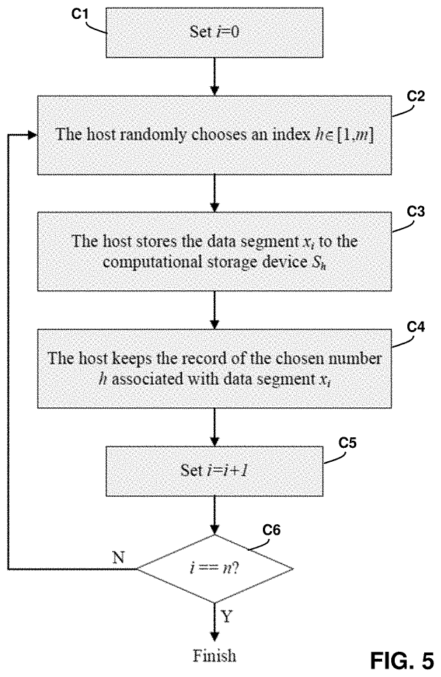

In a first randomized data placement method, illustrated in FIG. 5, the host 22 randomly chooses the computational storage device 10 that will be used to process each data segment, independent from other data segments. The host 22 keeps a record of the randomly chosen data placement information. Recall that m denotes the number of computational storage devices 10. Given the data x=[x₀, x₁, . . . , xₙ₋₁], the host 22 randomly chooses an index h∈[1,m] for selecting a computational storage device Sₕ from the computational storage devices S₀, S₁, . . . , Sₘ₋₁.

In FIG. 5, at process C1, i is set to 0 (i=0). At process C2, the host 22 randomly chooses an index h∈[1,m]. At process C3, the host 22 stores the data segment xᵢ to the computational storage device Sₕ, At process C4, the host 22 maintains a record of the chosen number h associated with the data segment xᵢ. At process C5, i is incremented by 1 (i=i+1). The random selections continue until all of the n data segments have been processed (Y at process C6). The chosen computational storage devices Sₕ carry out streaming computations on the respective data segments x as previously described with regard to FIG. 4.

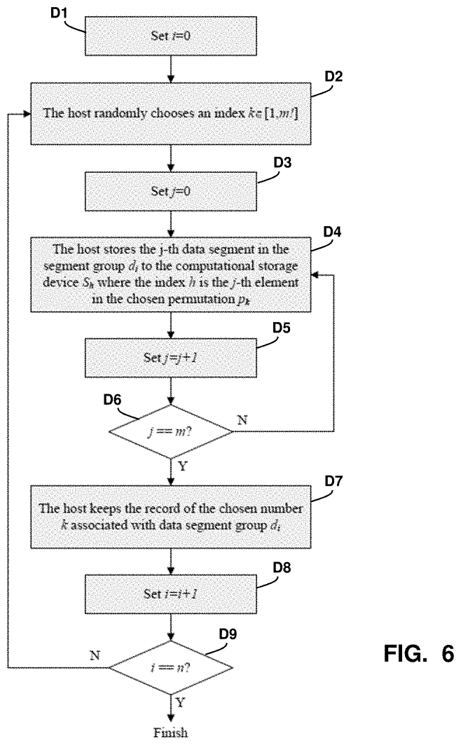

In a second randomized data placement method, it is first noted that, given the vector [0, 1, . . . , m−1], where m is the number of computational storage devices 10, there are total m! (i.e., the factorial of m) different permutations of the computational storage devices 10, where each unique permutation is denoted as pₖ with an index k∈[1,m!]. Given the data x=[x₀, x₁, . . . , xₙ₋₁] and m computational storage devices, without loss of generality, it is assumed that n is divisible by m, i.e., n=t·m where t is an integer. The data xis partitioned into t segment groups, where each segment group dᵢ=[x_{(i-1)·m}, x_{(i-1)·m+1}, . . . , x_{i·m-1}] contains m consecutive data segments xᵢ. For each segment group dᵢ, one permutation pₖ is randomly chosen and used to realize the data placement, i.e., the j-th data segment in the segment group dⱼ is stored on the computational storage device Sₕ, where the index h is the j-th element in the chosen permutation pₖ. The host 22 keeps the record of the index of the chosen permutation for each data segment group. The corresponding operational flow diagram is illustrated in FIG. 6.

At process D1 in FIG. 6, i is set to 0 (i=0). At process D2, the host 22 randomly chooses an index k∈[1,m!]. At process D3, j is set to 0 (j=0). At process D4, the host 22 stores the j-th data segment in the segment group dᵢ to the computational storage device Sₕ, where the index h is the j-th element in the chosen permutation pₖ. At process D5, j is incremented by 1 (j=j+1). If j=m (Y at process D6), flow passes to process D7. Otherwise (N at process D6), flow returns to process D4. At process D7, the host 22 maintains a record of the chosen number k associated with the segment group dᵢ. At process D8, i is incremented by 1 (i=i+1). The random selection continue until all of the n data segments have been processed (Y at process D9). The chosen computational storage devices Sₕ carry out streaming computations on the respective data segments x as previously described with regard to FIG. 4.

Advantageously, when using a randomized data placement (e.g., as depicted in FIGS. 5 and 6), consecutive data segments are stored on different computational storage devices 10, which ensures good data access parallelism. In addition, the randomized data placement can largely reduce resource contention when carrying out multiple streaming computation tasks in parallel.

It is understood that aspects of the present disclosure may be implemented in any manner, e.g., as a software program, or an integrated circuit board or a controller card that includes a processing core, I/O and processing logic. Aspects may be implemented in hardware or software, or a combination thereof. For example, aspects of the processing logic may be implemented using field programmable gate arrays (FPGAs), ASIC devices, or other hardware-oriented system.

Aspects may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

1. A host-assisted method for accelerating a streaming computation task, comprising:
storing a plurality of data segments x to be processed for the streaming computation task among a plurality of computational storage devices;
at the computational storage device in which a next data segment xᵢ be processed for the streaming computation task is stored:
receiving, from a host, an intermediate result uᵢ₋₁ of the streaming computation task;
performing a next streaming computation of the streaming computation task on the data segment xᵢ using the received intermediate result uᵢ₋₁ to generate an intermediate result uᵢ of the streaming computation task; and
sending the intermediate result uᵢ of the streaming computation task to the host.

2. The method according to claim 1, further comprising:
at the computational storage device in which a next data segment xᵢ₊₁ to be processed for the streaming computation task is stored:
receiving, from the host, the intermediate result uᵢ of the streaming computation task;
performing a next streaming computation of the streaming computation task on the data segment xᵢ₊₁ using the received intermediate result uᵢ to generate an intermediate result uᵢ₊₁ of the streaming computation task; and
sending the intermediate result uᵢ₊₁ of the streaming computation task to the host.

3. The method according to claim 1, wherein the plurality of data segments x are processed in sequence for the streaming computation task.

4. The method according to claim 3, further comprising:
repeating the receiving, performing, and sending, for each data segment x in sequence, at the computational storage device in which each data segment x to be processed for the streaming computation task is stored.

5. The method according to claim 1, further comprising randomly storing the plurality of data segments x to be processed for the streaming computation task in the plurality of computational storage devices.

6. A method for reducing resource contention while performing a plurality of streaming computation tasks in a system including a host coupled to a plurality of computational storage devices, comprising:
for each of the plurality of streaming computation tasks:
for each data segment of a plurality of data segments to be processed for the streaming computation task:
randomly choosing a computational storage device from the plurality of computational storage devices; and
storing the data segment to be processed for the streaming computation task in the randomly chosen computational storage device.

7. The method according to claim 6, further comprising maintaining, by the host, a record of the computational storage device in which each data segment is stored.

8. The method according to claim 6, further comprising performing the plurality of streaming computation tasks concurrently.

9. The method according to claim 6, wherein the plurality of computational storage devices includes m computational storage devices S₀, S₁, . . . , Sₘ₋₁, wherein randomly choosing further comprises:
randomly choosing, by the host, an index h given by h∈[1,m] to select a computational storage device Sₕ from the plurality of computational storage devices S₀, S₁, . . . , Sₘ₋₁.

10. The method according to claim 9, further comprising maintaining a record, by the host, of the index h associated with each data segment.

11. The method according to claim 6, wherein the plurality of computational storage devices includes m computational storage devices, and wherein there are a total of m! unique permutations pₖ of the computational storage devices, where k is an index given by k∈[1,m!], wherein randomly choosing further comprises:
randomly choosing, by the host, an index k to randomly select a permutation pₖ of the computational storage devices; and
selecting a combinational storage device from the randomly selected permutation pₖ of the computational storage devices for storing the data segment.

12. The method according to claim 6, wherein for each of the plurality of streaming computation tasks:
at the computational storage device in which a next data segment to be processed for the streaming computation task is stored:
receiving, from the host, an intermediate result of the streaming computation task;
performing a next streaming computation of the streaming computation task on the data segment sing the received intermediate result to generate an intermediate result of the streaming computation task; and
sending the intermediate result of the streaming computation task to the host.

13. A storage system for performing a streaming computation task, comprising:
a plurality of computational storage devices for storing a plurality of data segments x to be processed for the streaming computation task; and
a host coupled to the plurality of computational storage devices,
wherein, the computational storage device in which a next data segment xᵢ to be processed for the streaming computation task is stored is configured to:
receive, from the host, an intermediate result uᵢ₋₁ of the streaming computation task;
perform a next streaming computation of the streaming computation task on the data segment xᵢ using the received intermediate result uᵢ₋₁ to generate an intermediate result uᵢ of the streaming computation task; and
send the intermediate result uᵢ of the streaming computation task to the host.

14. The system according to claim 13, wherein the computational storage device in which a next data segment xᵢ₊₁ to be processed for the streaming computation task is stored is configured to:
receive, from the host, the intermediate result uᵢ of the streaming computation task;
perform a next streaming computation of the streaming computation task on the data segment xᵢ₊₁ using the received intermediate result uᵢ to generate an intermediate result uᵢ₊₁ of the streaming computation task; and
send the intermediate result uᵢ₊₁ of the streaming computation task to the host.

15. The system according to claim 13, wherein the plurality of data segments x to be processed for the streaming computation task in the plurality of computational storage devices are randomly stored in the plurality of computational storage devices.

16. The system according to claim 15, wherein the plurality of computational storage devices includes m computational storage devices S₀, S₁, . . . , Sₘ₋₁, wherein randomly storing further comprises, for each data segment:
randomly choosing, by the host, an index h given by h∈[1,m] to select a computational storage device Sₕ from the plurality of computational storage devices S₀, S₁, . . . , Sₘ₋₁; and
storing the data segment in the computational storage device Sₕ.

17. The system according to claim 15, wherein the plurality of computational storage devices includes m computational storage devices, and wherein there are a total of m! unique permutations pₖ of the computational storage devices, where k is an index given by k∈[1,m!], wherein randomly storing further comprises, for each data segment:
randomly choosing, by the host, an index k to randomly select a permutation pₖ of the computational storage devices;
selecting a combinational storage device from the randomly selected permutation pₖ of the computational storage devices for storing the data segment; and
storing the data segment in the selected computational storage device.
